(19) United States
(12) Patent Application Publication
(10) Pub. No.: US 2026/0013417 A1
(43) Pub. Date: Jan. 15, 2026

(54) Coulter System And Seeder Having Such A Coulter System

(71) Applicant: PÖTTINGER Landtechnik GmbH, Grieskirchen (AT)

(72) Inventors: Hans-Georg Kraus, Grieskirchen (AT); Alois Kirchmayr, Grieskirchen (AT)

(21) Appl. No.: 19/265,266

(22) Filed: Jul. 10, 2025

(30) Foreign Application Priority Data
Jul. 11, 2024 (DE) 10 2024 119 719.6

(51) Int. Cl. A01C 5/06; A01B 15/16

(52) U.S. Cl. CPC A01C 5/068; A01C 5/064; A01B 15/16

(57) ABSTRACT

A coulter system for an agricultural machine including a coulter disk for pulling a sowing furrow, a depth guide roller for working depth guidance of the coulter disk and a pressure roller running behind the coulter disk for pressing material deposited in the sowing furrow and/or closing the sowing furrow. A seeder having such a coulter system is also disclosed. The depth guide roller and the pressure roller are mounted in the manner of a bogey chassis on a common, rockable suspension support, wherein the depth guide roller is arranged overlapping with and adjacent to an end face of the coulter disk and forms a scraper for scraping soil from the coulter disk.

### CROSS-REFERENCE TO RELATED APPLICATIONS

This application claims benefit under 35 USC § 119 of DE Application No. 10 2024 119 719.6 filed 11 Jul. 2024, which is incorporated herein by reference in its entirety as if set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention relates to a coulter system for an agricultural machine, comprising a coulter disk for pulling a sowing furrow, a depth guide roller for working depth guidance of the coulter disk and a pressure roller running behind the coulter disk for pressing material deposited in the sowing furrow and/or closing the sowing furrow. The invention also relates to a seeder having such a coulter system.

### 2. Description of Related Art

Agricultural application machines for spreading granular material such as seed and/or fertilizer, for example in the form of seed drills for direct sowing, often comprise a coulter system in which a coulter disk pulls a sowing furrow and a pressure roller running behind the coulter disk presses the material deposited on the sowing coulter such as seed or fertilizer and/or closes the sowing furrow, wherein a pair of twin pressure rollers can also run behind a sowing coulter in order to close the sowing furrow from both sides. Such twin pressure rollers can have coaxial axes of rotation, but can also be positioned slightly V-shaped in relation to each other, so that the distance between the twin pressure rollers increases upwards away from the ground, wherein the twin pressure rollers can run essentially at the same height when viewed in the direction of travel, regardless of a possible V-position.

For example, the EP 3 878 259 A1 shows a pressure roller running behind the coulter disk, wherein the pressure roller is mounted together with the coulter disk in the manner of a bogey chassis on a common swivel suspension support.

The coulter disk can be arranged tilted in a manner known per se, wherein the axis of rotation of the coulter disk can, on the one hand, be tilted by an acute angle relative to a horizontal plane and/or, on the other hand, can be tilted by an equally acute angle relative to an upright plane extending transversely to the direction of travel, so that the coulter disk pulls a furrow of the desired width and depth. Depending on the design of the coulter disk, however, only a simple tilting or no tilting of the coulter disk at all can be provided.

Irrespective of the tilting of the coulter disk, the coulter system can, in addition to the pressure roller, have a depth guide roller to guide the coulter disk at a desired working depth. Such depth guide rollers can also be arranged running behind the coulter disk and positioned offset a little transversely to the direction of travel so as not to run in the sowing furrow, cf. for example the DE 10 2008 044 520 A1. Alternatively, it is also known to have two depth guide rollers running to the right and left of the coulter disk at approximately the same height, cf. for example the U.S. Pat. No. 7,191,715 B2.

In order to be able to adjust the working depth of the coulter disk, the coulter disk itself can be height-adjustable, for example by tilting or pivoting the coulter disk carrier. Coulter disks are often suspended from a coulter disk support arm, which is elastically suspended from a cross beam via rubber bearing sausages or in some other way and extends diagonally downwards to the rear of the coulter disk. If the cross member is rotated, the initial swivel position of the coulter disk support arm and thus the height of the coulter disk changes. Alternatively, or additionally, the depth guide roller can also be suspended in a height-adjustable manner, for example by means of a rocker that can be moved lower or higher via a length-adjustable strut or a length-adjustable spring band.

Even with multiple adjustment options, the depth guide of the coulter disk at the desired working depth is a complex parameter to set, as vertical forces are also exerted on the coulter system by the pressure roller running behind the coulter disk, which counteract the downward penetration force of the coulter disk or add up with the supporting forces of the depth guide roller. The coulter system not only reacts sensitively with regard to the setting of the working depth per se, but the smooth running of the coulter disk may also suffer, in particular if it is arranged tilted in the manner, if the ground contact forces are distributed in different ways to the depth guide roller and the pressure roller or are applied to different degrees by the depth guide roller on the one hand and the pressure roller on the other.

Proceeding therefrom, it is the underlying object of the present invention to create an improved coulter system and an improved seeder of the type, which avoid the disadvantages of the prior art and further develop the latter in an advantageous manner. In particular, a variably adjustable, exact depth guidance of the sowing coulter is to be achieved for exact placement accuracy of the seed or fertilizer without compromising the smooth running of the sowing coulter.

### SUMMARY OF THE DISCLOSURE

According to the invention, the problem is solved by a coulter system comprising a coulter disk for pulling a sowing furrow, a depth guide roller for working depth guidance of the coulter disk and a pressure roller running behind the coulter disk for pressing material deposited in the sowing furrow and/or closing the sowing furrow, characterized in that the depth guide roller and the pressure roller are mounted in the manner of a bogey chassis on a common, rockable suspension support, wherein the depth guide roller is arranged overlapping with and adjacent to an end face of the coulter disk and forms a scraper for scraping soil from the coulter disk. The problem is also solved by a seeder comprising such a coulter system/

It is therefore proposed to suspend the depth guide roller and the pressure roller together or to combine them on a common suspension and to arrange the depth guide roller directly adjacent to the coulter disk, which not only benefits increased running smoothness, but also minimizes unwanted throwing up of clods or soil by the coulter disk. According to the invention, the depth guide roller and the pressure roller are mounted on a common, rockable suspension support in the manner of a bogey chassis, wherein the depth guide roller is arranged overlapping with and adjacent to an end face of the coulter disk and forms a scraper for scraping soil from the coulter disk.

Thanks to the bogey suspension of the depth guide roller and the pressure roller on a common, rocking suspension support, the ground is no longer only scanned at certain points, but is distributed over the two contact points of the depth guide roller and the pressure roller, which are spaced apart from each other in the direction of travel. On the one hand, this makes it possible to achieve a uniform contact force, which is essentially maintained even when the system is adjusted to change the working depth and does not become unbalanced. On the other hand, the coupling of the depth guidance and pressure rollers on a common, rocking suspension support is conducive to the smooth running of the coulter system. At the same time, the depth guide roller can scrape off clods of soil that stick to the coulter disk due to its arrangement directly to the side of and overlapping with the coulter disk, which not only prevents the unwanted spraying of soil, but also reduces running smoothness by eliminating imbalances caused by clods of soil sticking to the coulter disk. In addition, the bogey-type chassis suspension is given additional lateral stability by the position of the depth guide roller immediately adjacent to the coulter disk.

In a further development of the invention, the depth guide roller can be arranged in such a manner that, when the coulter system is viewed lying in a viewing direction transverse to the direction of travel, a point of intersection of the outer circumferences of the coulter disk and the depth guide roller lies at least approximately in the area of the exit point at which the coulter disk exits the sowing furrow or leaves the ground. Depending on the working depth, the exit point may shift slightly or move along the circumference of the coulter disk, but the exit point is regularly in the range from about 7 o'clock to 8 o'clock when the coulter disk rotates clockwise, i.e., the exit point is in the rear half of the coulter disk, more precisely in its lower, rear quadrant. The depth guide roller is advantageously arranged in such a way that, when the coulter system is viewed lying in a viewing direction transverse to the direction of travel, the circumferential line of the depth guide roller intersects with the circumferential line of the coulter disk approximately in the area of the exit point.

The depth guide roller has two points of intersection with the coulter disk at which the respective circumferential lines intersect, wherein there is an upper and a lower point of intersection. The depth guide roller is arranged in such a manner that the lower point of intersection is in the area of the exit point at which the coulter disk exits the sowing furrow or leaves the ground.

Due to such an arrangement, i.e., an overlapping with a point of intersection in the area of the exit point of the coulter disk, soil adhering to the coulter disk can be scraped off very early or soil adhering to the coulter disk remains directly in the soil or on the soil surface, so that the coulter disk cannot pull up lumps of soil, dust and the like in the first place, but all the soil remains on the ground. Pulling up clods of soil is a problem, especially in damp soil, when the soil sticks to the coulter disks, causing the soil to be thrown around or scattered. In order to cut a clean sowing furrow without throwing the soil upwards, it is very helpful if the depth guide roller is arranged in the manner so that it forms a scraper to scrape the coulter disk, in particular if the point of intersection assumes the position described.

The depth guide roller is advantageously arranged in such a manner that the point of intersection with the coulter disk is located in a rear half of the depth guide roller, in particular in a rear lower quadrant of the depth guide roller.

In an advantageous further development of the invention, the axis of rotation of the depth guide roller can be located between the axis of rotation of the coulter disk and the rearmost circumferential point of the coulter disk when viewed in the direction of travel, wherein the axis of rotation of the depth guide roller can be located a little further up or a little further down or can move up and down depending on the luffing position of the bogey-type suspension support. Advantageously, the arrangement can be such that the axis of rotation of the depth guide roller lies within the circumference of the coulter disk, in particular in a rear half of the coulter disk or the coulter disk contour, when the coulter system is viewed lying in a viewing direction transverse to the direction of travel.

In order to distribute the ground contact forces of the jointly suspended depth guide and pressure rollers to the depth guide roller on the one hand and the pressure roller on the other in the desired manner, in a further development of the invention the joint, luffing suspension support can be mounted eccentrically, so that the distance of the axis of rotation of the depth guide roller from the luffing axis of the suspension support deviates from the distance of the axis of rotation of the pressure roller from the luffing axis. The rocking suspension support is therefore itself asymmetrical or mounted asymmetrically.

In particular, the luffing axis of the common suspension support may be closer to the pressure roller than to the depth guide roller in order to provide a greater proportion of the pressure to the pressure roller. For example, the distance of the pressure roller axis of rotation from the luffing axis of the suspension support and the distance of the depth guide roller axis of rotation from the luffing axis can be divided in a ratio to each other in the range of 20:80 to 40:60 or 25:75 to 33:67.

In an advantageous further development of the invention, the bogey-like, common suspension of the depth guide roller and the pressure roller is variably configured or adjustable with regard to the spacing ratio or with regard to the asymmetry of the luffing axis, so that, depending on the ground conditions, the common, luffing suspension support can be mounted more or less asymmetrically in order to shift the ratio of the contact forces more or less strongly towards the pressure roller.

Advantageously, the bogey suspension is configured in such a manner that the point of intersection of the outer circumferences of the depth guide roller and coulter disk remains at least essentially unchanged in the area of the exit point, at which the coulter disk exits the sowing furrow or leaves the ground, even if the asymmetries are set to different degrees. Such adjustability of the asymmetry or the lever ratios on the luffing bogey support, which leaves the point of intersection between the depth guide roller and sowing coulter essentially unchanged, can for example comprise an adjustable bearing block, which can be shifted more towards the depth guide roller or shifted more towards the pressure roller when viewed in the direction of travel, while at the same time the luffing axis can be fixed accordingly at different points of the common, luffing suspension support.

For example, the suspension support can comprise an elongated hole in which the luffing axis can be displaced when the bearing block is displaced, wherein the luffing axis can then be fixed, for example, by means of displaceable stops that can be adjusted in different positions. As an alternative to an elongated hole, the suspension support can also form a hole with several luffing axis recesses so that the luffing axis can be inserted into a hole located further forward or further back when the bearing block is adjusted.

Alternatively, or additionally, the suspension support can also be configured to be length-adjustable, e.g., telescopic, in particular in a portion between its luffing axis and the pressure roller.

Alternatively, or additionally, the adjustability of the asymmetry of the bogey suspension of the depth guide roller and pressure roller can also include an adjustable mounting of the pressure roller on the common suspension support. For example, the axis of rotation of the pressure roller can be positioned in different positions on the common suspension support, sometimes closer to the luffing axis and sometimes further away from the luffing axis of the suspension support. An elongated hole can also be used here by moving the axis of rotation of the pressure roller and fixing it, for example, in a stepless or stepped manner using adjustable stops.

Alternatively, or in addition to an elongated hole, a hole pattern with several separate bearing recesses can also be provided for positioning the axis of rotation of the pressure roller on the common, rocking suspension support. In this case, the asymmetry of the positioning of the luffing axis between the pressure roller and depth guide roller can be adjusted by repositioning the axis of rotation of the pressure roller in a hole located further forward or further back, without the desired point of intersection between the outer circumferences of the depth guide roller and coulter disk being adjusted.

In order to improve the scraping effect of the depth guide roller, in a further development of the invention, the running surface of the depth guide roller or its circumferential contour can be designed asymmetrical when viewed in a cross-section containing the axis of rotation of the depth guide roller. In particular, the part of the circumferential contour facing the coulter disk or the outer edge section of the depth guide roller can be formed differently than the corresponding part of the circumferential contour or the edge section facing away from the coulter disk.

Advantageously, the depth guide roller can have a bent-chip contour in the transition region from the running surface to the side wall on the side facing the coulter disk. For example, the depth guide roller can have an acute angle edge towards the coulter disk, for example from the side wall facing the coulter disk at an approximately right angle or an angle <90° merging into the running surface.

In a further development of the invention, the running surface of the depth guide roller, viewed in a cross-section containing the axis of rotation, can be slightly concavely arched and rise towards the side walls, wherein the transition to the side wall facing the coulter disk can be angular and/or essentially without a rounding radius, while the transition to the side wall on the side facing away from the coulter disk can be rounded.

The scraper effect can be considerably improved by an angular contour towards the coulter disk, in particular in combination with a running surface contour that rises towards the edge, so that an overall acute-angled roller edge can scrape along the coulter disk.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The invention is explained in more detail below with reference to a preferred embodiment and the corresponding drawings. The drawings show:

FIG. 1 is a side view of the coulter system of a seeder according to an advantageous embodiment of the invention, wherein the coulter disk and the depth guide roller of the coulter system are shown in an intended working position, in which a point of intersection of the circumferential contours lies approximately in the area of an exit of the coulter disk from the soil.

FIG. 2 is a side view of the coulter system from an opposite side compared to FIG. 1, showing the suspension of the coulter disk and the common, rocking suspension support for the depth guidance and pressure rollers as well as the spreading element arranged on the coulter disk.

FIG. 3 is a top view of the coulter system from the previous figures, showing the direct side-by-side arrangement of coulter disk and depth guide roller.

FIG. 4 is a side view of the coulter system similar to FIG. 1, wherein the bogey-like suspension of the depth guide roller and the pressure roller is shown in a tilted position in which the depth guide roller is lower than the pressure roller.

FIG. 5 is a side view of the coulter system, showing the bogey-type suspension in an inverted tilted position, in which the depth guide roller runs higher than the pressure roller.

FIG. 6 is a side view of a coulter system similar to FIG. 1, in which the depth guide roller is larger than the coulter disk.

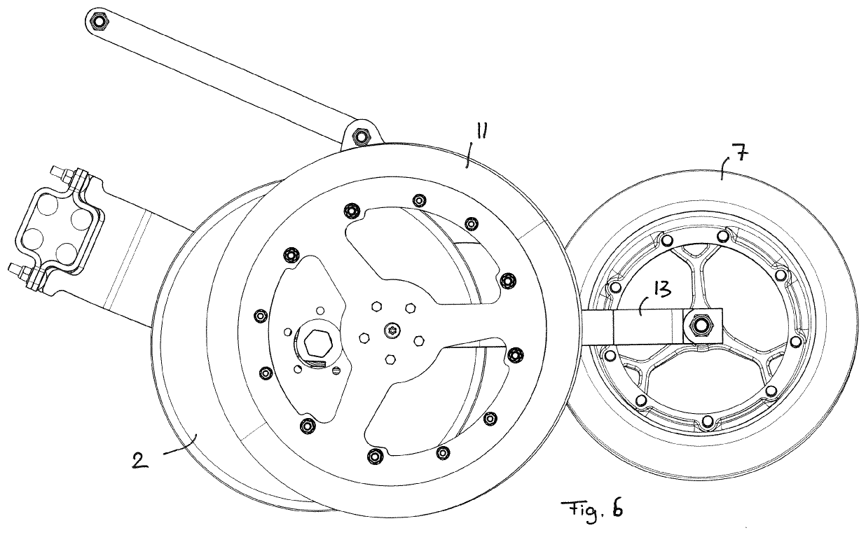

FIG. 7 is a side view of a coulter system similar to FIG. 1, wherein the common, luffing suspension support, on which the depth guide roller and the pressure roller are mounted together, has a significantly shorter distance between the axis of rotation of the pressure roller and the luffing axis of the support compared to the previous figures.

FIG. 8 is a top view of the coulter system from FIG. 7.

FIG. 9 is a side view of a coulter system similar to FIG. 1, wherein the common, rocking suspension support, on which the depth guide roller and the pressure roller are mounted together, has an adjustment option for different lever arm ratios and thus different distributions of the contact forces for the depth guide roller and the pressure roller.

FIG. 10 is a side view of a coulter system similar to FIG. 1, where the different adjustment options for setting the working depth are shown schematically.

FIG. 11 is a top view of a coulter system similar to FIG. 3, wherein the pressure roller is in the form of twin pressure rollers which have a common pivot point on the rocking suspension support of the bogey-type suspension.

FIG. 12 is a sectional view of the rocking mounting of the common suspension support for the depth guidance and pressure rollers, showing the pendulum stops for limiting the rocking movement of the suspension support.

### DETAIL DESCRIPTION OF THE INVENTION

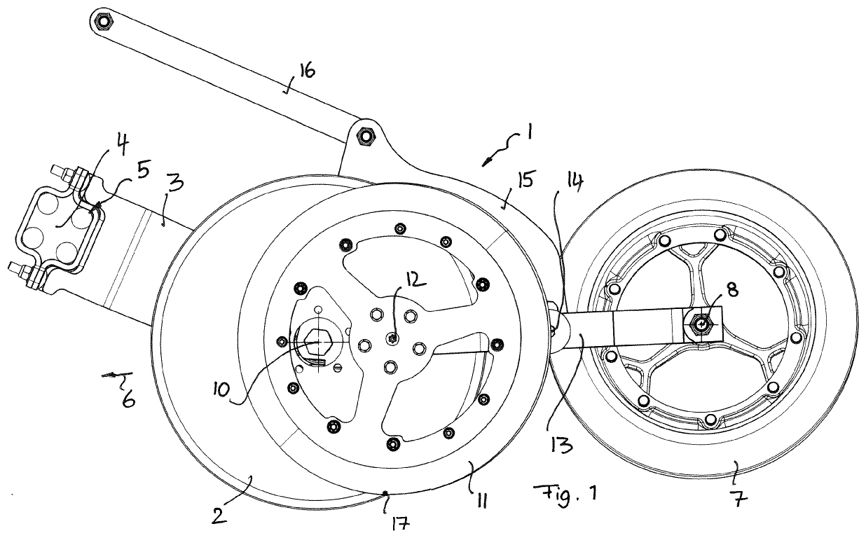

As shown in the figures, the coulter system 1 comprises a coulter disk 2, which can be rotatably mounted on a coulter carrying arm 3, which can extend from its suspension point obliquely downwards to the rear towards the coulter disk 2, cf. FIG. 1. The coulter carrying arm 3 can, for example, be elastically rockably mounted on a cross member 4, for example by means of a rubber-elastic crush bearing 5, cf. FIG. 1. The cross member 4 can extend horizontally transversely to the direction of travel 6 of the seeder and mount a plurality of such coulter carrying arms 3 in order to suspend a corresponding plurality of coulter disks 2 in a row next to each other. It is understood that the coulter system 1 may comprise not only one coulter disk and not one associated pair of depth guidance and pressure rollers, but a plurality of such coulter disks arranged in a row side by side together with associated depth guidance and pressure rollers.

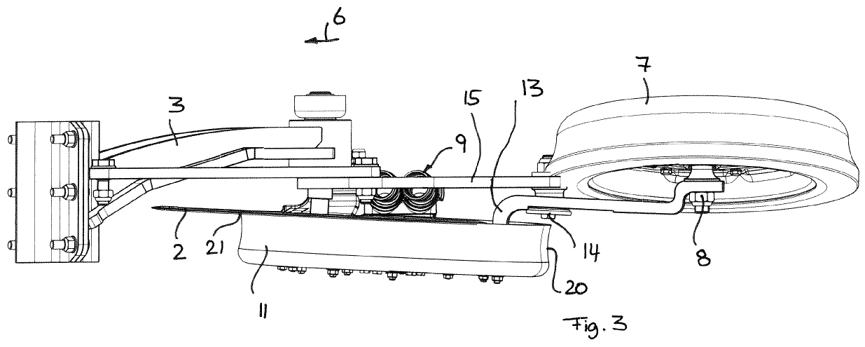

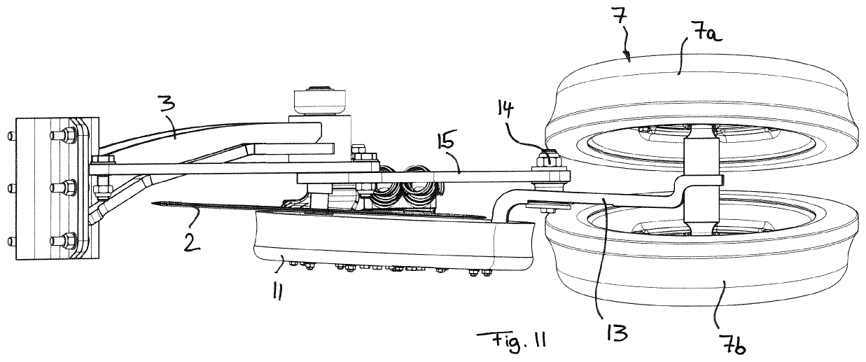

As shown in the figures, the coulter system 1 further comprises a pressure roller 7 running behind the coulter disk 2 to press seed deposited in the sowing furrow drawn by the coulter disk 2 and/or to close the sowing furrow. The pressure roller 7 can be a single roller, as shown for example in FIG. 3, or also comprise a twin pressure roller 7a, b, as shown in FIG. 11, wherein such twin pressure rollers 7a, b can be arranged spread apart in a V-shape in such a way that the distance gap between the twin pressure rollers increases from bottom to top, cf. FIG. 11. In the case of a single pressure roller 7, this can also have a tilted arrangement, in particular with its axis of rotation 8 tilted at an acute angle to a horizontal plane, although a non-tilted arrangement is also possible.

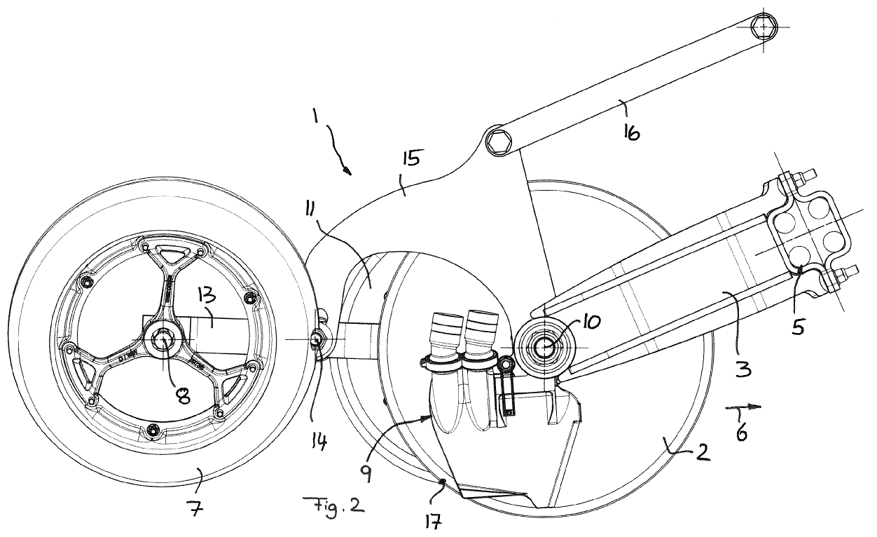

In order to be able to place seed or possibly also fertilizer directly in the sowing furrow drawn by the coulter disk 2, the seeder can have a spreading element 9, which can be arranged directly on the coulter disk 2, for example on the coulter disk sowing, on which the coulter disk 2 is mounted with its axis of rotation 10 on the coulter carrying arm 3, cf. FIG. 2 and FIG. 3.

In addition to the pressure roller 7, the coulter system 1 comprises a depth guide roller 11, which can advantageously be positioned further forward in the direction of travel 6 compared to the pressure roller 7, cf. FIG. 1.

In particular, the depth guide roller 11 may be positioned immediately adjacent to and overlapping with the coulter disk 2 and form a scraper or scraper roller which can scrape off clods of soil, crumbs and the like adhering to the coulter disk 2.

As shown in the figures, the pressure roller 7 and the depth guide roller 11 are attached by their axes of rotation 8 and 12 to a common suspension support 13, which is mounted in the area between the axes of rotation 8 and 12 of the pressure roller 7 and the depth guide roller 11 so that it can luff about a luffing axis 14. The luffing axis 14 can, in particular, extend horizontally transverse to the direction of travel 6.

With the luffing axis 14, the suspension support 13 is suspended from an articulation beam 15, which can advantageously be height-adjustable in order to adjust the height of the articulation point of the luffing suspension support 13 for the pressing and depth guide rollers 7, 11 and thus to be able to adjust the working depth of the coulter disk 2.

For example, the articulation beam 15 can be mounted pivotably in order to be able to change the height of the suspension support 13 by pivoting, wherein the articulation beam 15 can be mounted so as to pivot about a pivot axis transversely to the direction of travel 6. For example, the articulation beam 15 can be suspended from the coulter carrying arm 3, in particular in the area of the axis of rotation 10 of the coulter disk 2.

In particular, the articulation beam 15 can form part of a four-bar linkage, which on the one hand comprises the pivotable coulter carrying arm 3 and on the other hand comprises a support strut 16, which on the one hand is mounted articulatedly on the articulation beam 15 and on the other hand is mounted articulatedly on a machine frame section or an articulation bracket connected thereto, wherein the support strut 16 or a connecting line can extend at least approximately parallel to the coulter carrying arm 3 through its articulation points, cf. FIG. 2. For example, the support strut 16 can be configured to be length-adjustable in order to be able to adjust the height of the suspension support 13. Alternatively, or additionally, one of the pivot points of the support strut 16 can also be designed to be displaceable in order to be able to displace the support strut 16 relative to the machine frame part and/or relative to the articulation beam 15 and thus to be able to pivot the articulation beam 15 for the purpose of height adjustment.

As FIGS. 1 to 3 show, the bogey-like suspension comprising the rocking suspension support 13 can guide the depth guide roller 11 directly adjacent to and overlapping with the coulter disk 2, so that a point of intersection 17, cf. FIGS. 1 and 2, between the outer circumferences of the coulter disk 2 on the one hand and the depth guide roller 11 on the other hand lies in the area of an exit point at which the coulter disk 2 emerges from the sowing furrow or leaves the soil. As intended, the coulter disk 2 dips into the soil with a secant section at the bottom, so that an end section of the dipping area at the rear in the direction of travel in the transition region to the disk part that does not cut into the soil defines the exit point, which at least approximately determines the position of the point of intersection 17.

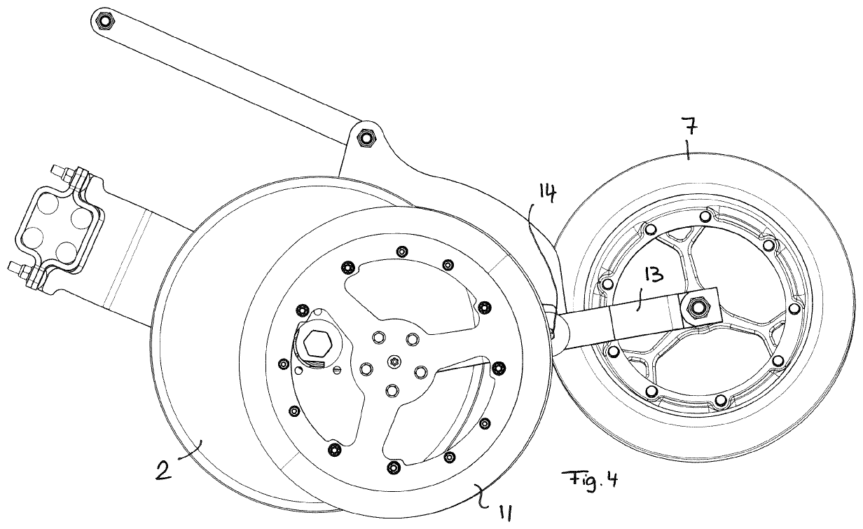

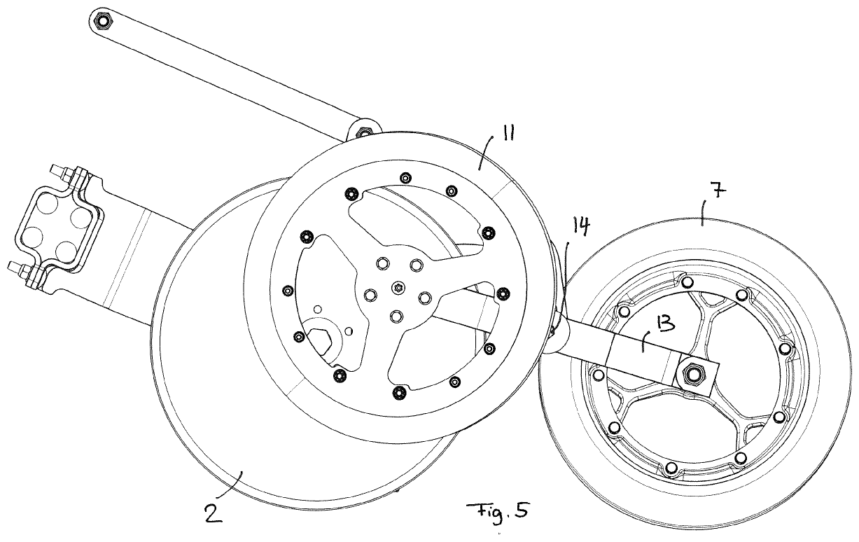

As illustrated in FIGS. 4 and 5, the depth guide roller 11—in tandem with and in the opposite direction to the pressure roller 7—can rock downwards or also upwards due to the rocking suspension of the suspension support 13, namely by rocking about the rocking axis 14. As the figures show, such rocking movements of the suspension support 13 and the corresponding up and down movement of the depth guide roller 11 relative to the coulter disk 2 also shift the point of intersection 17 between the outer circumferences of the depth guide roller 11 and the coulter disk 2, namely further down to the front, cf. FIG. 4 and further backwards and upwards, cf. FIG. 5. Nevertheless, in an intended working position, as shown in FIG. 1, the point of intersection 17 is in the area of the exit point at which the coulter disk 2 exits the furrow. Even in the adjusted positions according to FIGS. 4 and 5, the point of intersection 17 is still very close to the exit point and in any case still in the lower third of the coulter disk 2, so that the splashing up of clods of soil is prevented.

As shown the figures, the luffing axis 14 of the bogey-type suspension support 13 can be located at least approximately at the height of the axis of rotation 10 of the coulter disk 2, which can change depending on the height setting, and can be arranged just behind the coulter disk 2 or adjacent to the rear end of the coulter disk 2, cf. FIGS. 1 and 2.

In order to control or vary the distribution of the ground contact forces of the depth guide roller 11 and the pressure roller 7, the lever ratios of the suspension support 13 in relation to the luffing axis 14 can be adjusted or varied accordingly. For example, if more pressure is to be applied to the pressure roller 7 than to the depth guide roller 11, the partial length of the suspension support 13 from the luffing axis 14 to the pressure roller 7 can be shortened. More precisely, the distance between the luffing axis 14 and the axis of rotation 8 of the pressure roller 7 can be selected to be smaller than the distance between the luffing axis 14 and the axis of rotation 12 of the depth guide roller 11.

In order to achieve ground adaptation to different ground conditions, for example moist or dry soils, the leverage ratio of the suspension support 13 or its asymmetry with respect to the positioning of the luffing axis 14 can be changed. In the simplest embodiment of the invention, the suspension support 13 can be exchanged and replaced by another suspension support 13 which has different lever ratios or in which the ratio of the distances between the luffing axis 14 and the axis of rotation of the pressure roller, on the one hand, and the luffing axis 14 and the axis of rotation of the depth guide roller, on the other hand, is different.

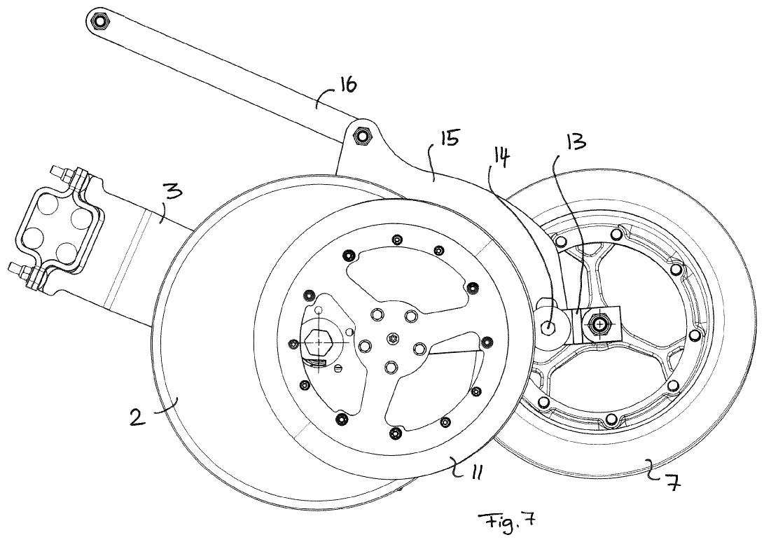

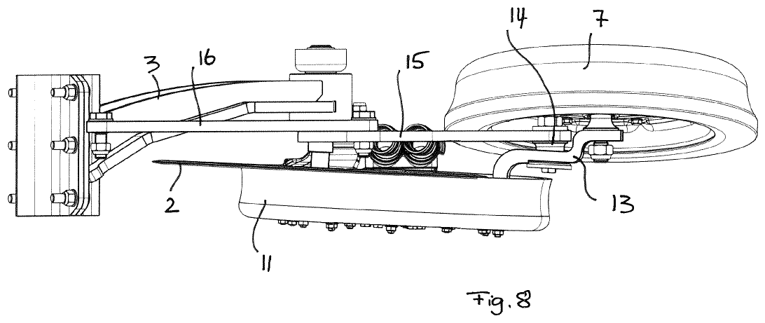

While in FIGS. 1-5 the luffing axis 14 is positioned at least approximately centrally between the axes of rotation of the pressure roller 7 and the depth guide roller 11 or is only slightly shifted towards the pressure roller 7, FIGS. 7 and 8 show an embodiment example in which the asymmetry is much more pronounced and the luffing axis 14 is positioned much closer to the axis of rotation 8 of the pressure roller 7. As a result, the pressure of the pressure roller 7 on the floor can be significantly higher than the pressure of the depth guide roller 11. For example, as FIG. 7 shows, the ratio can be 25:75, i.e., the partial length of the suspension support 13 between the luffing axis 14 and the pressure roller axis of rotation 8 can be 25% of the total length and the partial length between the luffing axis 14 and the axis of rotation 12 of the depth guide roller 11 can be 75% of the total length. Other length ratios are possible, as mentioned at the beginning.

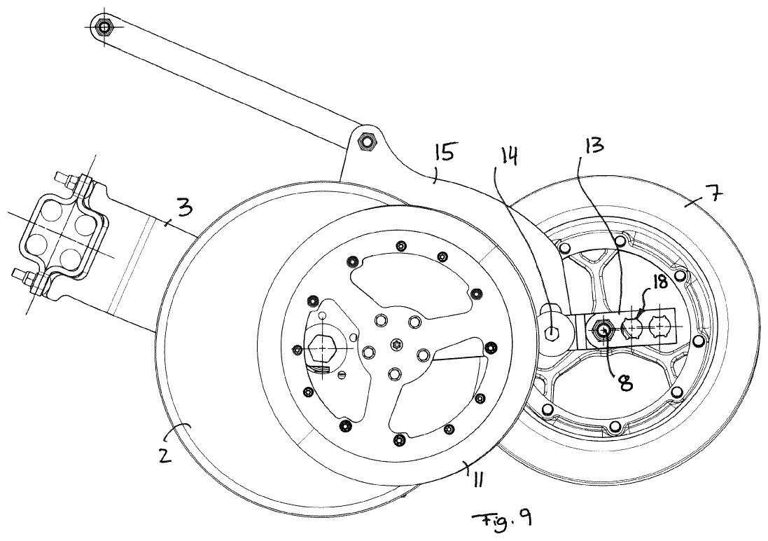

As shown in FIG. 9, the suspension support 13 can also have an adjusting device for variably adjusting the lever ratios or the asymmetry, for example in the form of a hole pattern 18 comprising different through recesses which are spaced at different distances from the luffing axis 14 and into which the axis of rotation 10 of the pressure roller 7 can be inserted. Alternatively, or in addition to such a hole pattern, an elongated hole could also be provided in the suspension support 13, in which the bearing of the pressure roller 7 can be displaced, wherein the desired position could be, for example, fixed by means of adjustable stops.

Adjusting the lever ratios by adjusting the pivot point of the pressure roller 7 has the advantage that the geometric ratios between the depth guide roller 11 and coulter disk 2 are not adjusted, in particular the point of intersection 17 is retained.

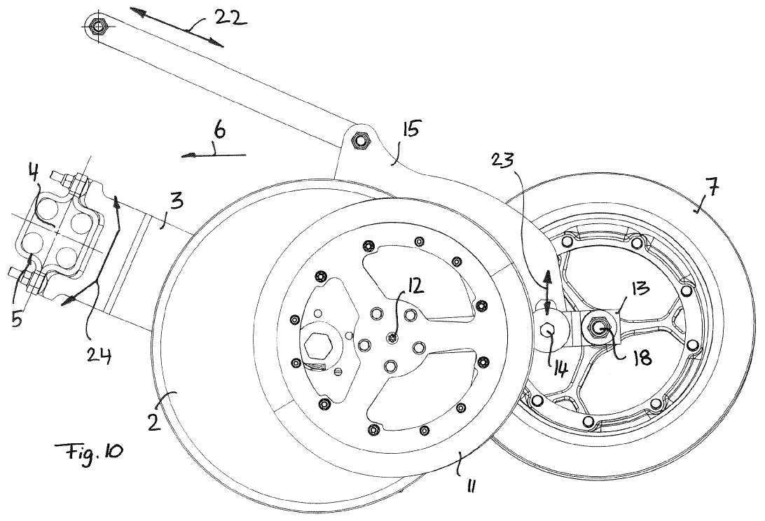

FIG. 10 illustrates the different adjustment options of the coulter system 1. As already briefly explained above, the height of the suspension support 13 can be adjusted by pivoting the articulation beam 15 in order to change the working depth of the coulter disk 2. For this purpose, for example, the support strut 16 can be changed in length or adjusted at its pivot point on the machine frame side, cf. arrow 22 in FIG. 10.

Alternatively, or additionally, the position of the luffing axis 14 on the articulation beam 15 can also be advantageously changed, in particular adjusted in height, cf. arrow 23 in FIG. 10. Such an adjustment of the luffing axis 14 relative to the articulation beam 15 can in particular achieve a fine adjustment, which can also be advantageous in particular in order to be able to adjust the coulter disks 2 lined up next to each other to the same working depths.

Alternatively, or additionally, it would also be possible to adjust the articulation point of the articulation beam 15 on the coulter carrying arm 3, for example via a slotted hole guide and associated adjustable stops. The rotational position of the articulation beam 15 can also be changed by such an adjustment, thus achieving a height adjustment of the luffing axis 14.

Furthermore, alternatively or additionally, it is also possible to adjust the basic position of the coulter carrying arm 3, for example by pivoting the cross member 4, which is also illustrated in FIG. 10, cf. arrow 24. This allows the four-bar link formed by the coulter carrying arm 3 and the support strut 16 to be adjusted and thus the height of the luffing axis 14 to be varied, which in turn leads to a corresponding change in the working depth of the coulter disk 2.

As shown in FIG. 11, provision can also be made for twin pressure rollers 7, which can be attached to the common, rocking suspension support 13 in a manner analogous to that shown in FIG. 11.

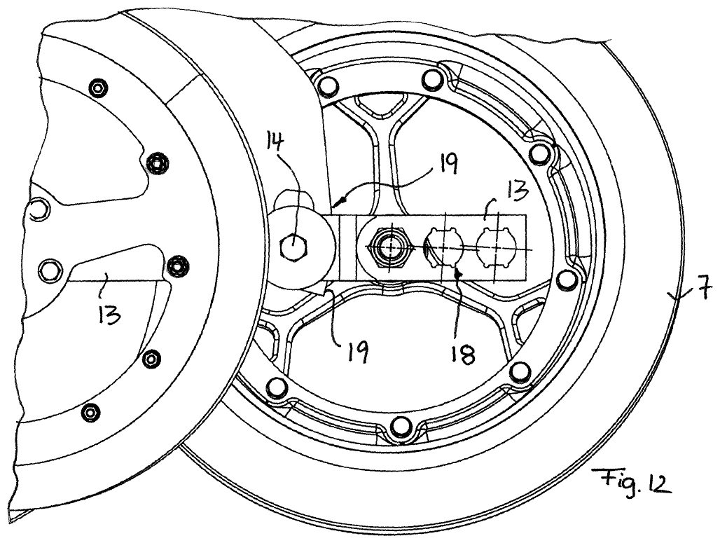

As shown in FIG. 12, the luffing ability of the suspension support 13 can be limited, for example by means of luffing stops 19, which allow the suspension support 13 to rest against the articulation beam 15 when the maximum permissible luffing position is reached, cf. FIG. 12.

In order to increase the scraping effect of the depth guide roller 11, the depth guide roller 11 may have an edge formed at an acute angle or without any noticeable rounding towards the coulter disk 2, which forms the transition region between the circumferential running surface and the side wall facing the coulter disk 2, cf. for example FIG. 3 and FIG. 11. The running surface 20 itself may be slightly concave, cf. FIG. 3 and FIG. 11, so that the running surface 20 rises towards the side walls, wherein the acute angle edge 21 may be provided towards the coulter disk 2. On the side facing away from the coulter disk 2, the transition of the running surface 20 to the side wall of the depth guide roller 11 can be rounded, cf. FIG. 3 and FIG. 11.

1. A coulter system for an agricultural machine comprising:
a coulter disk for pulling a sowing furrow;
a depth guide roller for working depth guidance of the coulter disk and;
a pressure roller running behind the coulter disk for pressing material deposited in the sowing furrow and/or closing the sowing furrow;
wherein:
the depth guide roller and the pressure roller are mounted in a manner of a bogey chassis on a common, rockable suspension support; and
the depth guide roller:
is arranged overlapping with and adjacent to an end face of the coulter disk; and
forms a scraper for scraping soil from the coulter disk.

2. The coulter system according to claim 1, wherein the depth guide roller is arranged in such a manner that, when viewed in a viewing direction transverse to a direction of travel, an intersection of outer circumferences of the coulter disk and the depth guide roller lies at least approximately in an area of an exit point at which the coulter disk exits the sowing furrow and/or leaves the ground.

3. The coulter system according to claim 2, wherein the intersection is located in a rear lower quadrant of the coulter disk.

4. The coulter system according to one of the foregoing claim 1, wherein:
the depth guide roller has an axis of rotation which, when viewed in a direction of travel, lies between an axis of rotation of the coulter disk and a rearmost circumferential point of the coulter disk;
an axis of rotation of the depth guide roller is offset upwards and downwards relative to a height of the axis of rotation of the coulter disk depending on a luffing position of the suspension support; and
the axis of rotation of the depth guide roller is positioned within a rear half of the coulter disk when the coulter system is viewed lying in a viewing direction transverse to a direction of travel.

5. The coulter system according to one of the foregoing claim 1, wherein:
the depth guide roller, when a cross section containing an axis of rotation of the depth guide roller is considered, has an acute angle transition edge and/or a bent-chip contour towards the coulter disk; and
the acute angle transition edge and/or the bent-chip contour forms a transition region between a circumferential running surface and a side wall of the depth guide roller facing the coulter disk.

6. The coulter system according to claim 5, wherein the circumferential running surface, when viewed from a cross-section containing the axis of rotation of the depth guide roller, is concavely arched and rises towards side walls.

7. The coulter system according to one of claim 1, wherein the suspension support is configured asymmetrical with respect to a position of a luffing axis of the suspension support.

8. The coulter system according to claim 7, wherein a partial length of the suspension support from the luffing axis to an axis of rotation of the pressure roller is shorter than a partial length of the suspension support from the luffing axis to an axis of rotation of the depth guide roller.

9. The coulter system according to claim 8, wherein a ratio of the partial length from the luffing axis to the axis of rotation of the pressure roller to the partial length from the luffing axis to the axis of rotation of the depth guide roller is in the range from 20:80 to 40:60.

10. The coulter system according to claim 7, wherein the suspension support is configured to be adjustable with respect to a strength of the asymmetry of the position of the luffing axis.

11. The coulter system according to claim 9 further comprising an adjusting device for adjusting the ratio of the partial length from the luffing axis to the axis of rotation of the pressure roller to the partial length from the luffing axis to the axis of rotation of the depth guide roller;
wherein the adjusting device is configured in such a manner that even for different partial length ratios, the depth guide roller maintains its positioning relative to the coulter disk.

12. The coulter system according to claim 11, wherein the adjusting device comprises an adjustable attachment for attaching the pressure roller to the suspension support at different distances from the luffing axis.

13. The coulter system according to claim 11, wherein the suspension support comprises a hole pattern for positioning the axis of rotation of the pressure roller in different positions on the suspension support.

14. The coulter system according to one of the two foregoing claim 1, wherein the suspension support is configured to be length-adjustable or telescopic, in particular between a luffing axis of the suspension support and the pressure roller.

15. The coulter system according to claim 1, wherein the suspension support is attached with a luffing axis of the suspension support to an articulation beam which is mounted in a height-adjustable and/or height-pivotable manner.

16. The coulter system according to claim 15, wherein the articulation beam is hingedly attached to a coulter carrying arm carrying the coulter disk and configured to be supported by a support strut on a machine frame carrying the coulter system.

17. The coulter system according to claim 16, wherein the articulation beam together with the coulter carrying arm carrying the coulter disk is part of a four-bar linkage.

18. (canceled)

19. The coulter system according to further comprising:
a working depth adjusting device; and
a coulter carrying arm carrying the coulter disk;
wherein the working depth adjusting device is provided for adjusting an initial position of the coulter carrying arm carrying the coulter disk.

20. A seeder comprising the coulter system of claim 1.

21. The coulter system according to claim 8, wherein a ratio of the partial length from the luffing axis to the axis of rotation of the pressure roller to the partial length from the luffing axis to the axis of rotation of the depth guide roller is in the range from 25:75 to 33:67.
